(19) United States
(12) Patent Application Publication
(10) Pub. No.: US 2026/0307285 A1
(43) Pub. Date: Oct. 8, 2026

(54) CUTTING TOOL

(71) Applicant: Rennsteig Werkzeuge GmbH, Steinbach-Hallenberg (DE)

(72) Inventors: Georg HOLLAND-MORITZ, Steinbach-Hallenberg (DE); Benjamin WEISHEIT, Floh-Seligenthal (DE)

(73) Assignee: Rennsteig Werkzeuge GmbH, Steinbach-Hallenberg (DE)

(21) Appl. No.: 19/477,959

(22) PCT Filed: Apr. 22, 2024
(86) PCT No.: PCT/EP2024/060925

§ 371 Date: Oct. 23, 2025

(30) Foreign Application Priority Data
Apr. 26, 2023 (DE) 10 2023 110 694.5
Jul. 20, 2023 (DE) 10 2023 119 164.0

(51) Int. Cl. B26D 3/16

(52) U.S. Cl. CPC B26D 3/169

(57) ABSTRACT

A cutting tool with two cutting parts, the cutting parts being connected to one another in a joint for pivoting movement relative to one another along a cutting plane. The first cutting part is considered stationary and the second cutting part is considered movable, which cutting parts define a cutting mouth in an open state. The second cutting part has two cutting edges enclosing an obtuse angle with one another, which cutting edges converge in a cutting tip. The cutting tip is formed so as to project, relative to an otherwise linear course of the cutting edges, in a pivoting direction r of the second cutting part. The second cutting part can be drivable by a ratchet drive and consists of a ratchet part provided with a toothing and a cutting-edge part. The cutting-edge part can be replaceably received in the ratchet part.

### CROSS REFERENCE TO RELATED APPLICATIONS

This application is the National Stage of PCT/EP2024/060925 filed on Apr. 22, 2024, which claims priority under 35 U.S.C. § 119 of German Application No. 10 2023 110 694.5 filed on Apr. 26, 2023 and German Application No. 10 2023 119 164.0 filed Jul. 20, 2023, the disclosures of which are incorporated by reference. The international application under PCT article 21(2) was not published in English.

### TECHNICAL FIELD

The invention relates to a cutting tool having two cutting parts, the cutting parts being connected to one another by a joint for a pivoting movement relative to each other along a cutting plane, wherein furthermore a first cutting part is regarded as stationary and a second cutting part as movable, the cutting parts defining, in an open state, a cutting mouth, the second cutting part additionally having two cutting edges enclosing an obtuse angle with one another and converging in a cutting tip.

The invention further relates to a cutting tool having two cutting parts, the cutting parts being connected to one another by a joint for pivoting movement relative to each other along a cutting plane, wherein furthermore a first cutting part is regarded as stationary and a second cutting part as movable, the cutting parts defining, in an open state, a cutting mouth, the second cutting part being drivable by a ratchet drive and consisting of a ratchet part provided with a toothing and a cutting-edge part.

### PRIOR ART

Cutting tools of the type in question are known in various configurations, for example for cutting pipes, in particular plastic pipes, or also electrical cables, in particular underground cables. In this case, the cutting parts of the cutting tool delimiting the cutting mouth may each be designed in the form of a blade. Configurations are also known in which only one cutting part, in particular the movable cutting part, is formed in the manner of a blade. The other cutting part may serve merely to support the material to be cut in the region of the cutting mouth.

From US 2020/0016670 A1, a cutting tool is known in which the movable cutting part has two cutting edges which converge in a cutting tip while enclosing an obtuse angle with one another. The second cutting part projects in the stop-limited basic position in a cantilevered manner and is formed in one piece with the ratchet part.

Reference is further made to DE 297 01 450 U1 as prior art. The disclosure of this publication corresponds, with respect to the features mentioned, to that of US ′670 A1.

From EP 827 815 A1, a cutting tool is known in which, likewise, two cutting edges on the movable blade enclose an obtuse angle with one another and are each formed to extend linearly, thereby forming the cutting tip. The movable cutting part is fixedly connected to the movable handle part. In the stop-limited basic position, it projects beyond the tool body.

From US 2018/272445 A1, a cutting tool for cutting U-shaped angle sheets is known. The movable cutting part has, over most of its length, a curved cutting edge. The curved cutting edge merges, via an outward kink, into a tip, while the other flank of the tip is formed straight and continuous. The movable cutting part projects freely outward in the stop-limited basic position. The cutting part is replaceably received in a drive part.

From US 2002/148118 A1, a cutting tool is known in which, likewise, the movable cutting part is formed with cutting edges extending straight and enclosing an acute angle with one another, the cutting edges merging into a cutting tip without any interruption of linearity. The cutting tool comprises lever parts connected to one another by a joint at their ends remote from the handles, one of which is provided with a stationary blade.

From CN 211915666 U, a cutting tool is known in which the movable cutting part is received in an opening of the ratchet part, and in which, for retaining the cutting part, a plate part is to be fastened on both sides of the ratchet part so as to overlap the received region of the movable cutting part. In a basic position, only the movable cutting part forms a portion of the cutting mouth. The movable cutting part lies exposed.

### SUMMARY OF THE INVENTION

Starting from prior art as known from US 2020/0016670 A1 with respect to the initially mentioned subject matter, the object is to provide a cutting tool enabling an advantageous execution of a cutting operation.

Starting from prior art as given by CN 211915666 U, the object of the invention is to provide a cutting tool with two cutting parts in which the movable cutting part is advantageously held or received.

The object mentioned first is achieved a cutting tool having two cutting parts, the cutting parts being connected to one another in a joint for pivoting movement relative to one another along a cutting plane. The first cutting part is considered stationary and the second cutting part is considered movable, which cutting parts define a cutting mouth in an open state. The second cutting part has two cutting edges enclosing an obtuse angle with one another, which cutting edges converge in a cutting tip. The cutting tip, relative to an otherwise linear course of the cutting edges, is formed to project in a pivoting direction of the second cutting part by a projection amount, and that, in a stop-limited basic position, the second cutting part lies substantially completely between the leg-forming partial sections of the tool body in a protected recessed position.

By virtue of the cutting tip thus formed, an advantageously configured cutting tool is created. The cutting tip, which is formed to be exposed in the pivoting direction starting from an open position of the cutting mouth towards a closed position of the cutting mouth, brings about-when the cutting tool is handled in an advantageous manner-a favorable cutting path during the cutting severance of a material to be cut. When cutting a material to be cut, as compared with a cutting tool without such a projecting cutting tip, a (first) penetration of the second cutting part through or into the wall of the material to be cut may occur before the linearly extending cutting edges follow, and this moreover in an advantageous manner with reduced expenditure of force.

As a result of the action of the cutting tip on the material to be cut, at least at the beginning of the cutting operation, an initially approximately point-like loading of the outer wall of the material to be cut by the cutting tip may occur, whereby a force application promoting the cutting effect can be achieved.

According to a preferred embodiment of the invention, it is provided that the longitudinal edges of the positive-fit receptacle are of different lengths, wherein a longitudinal edge leading in the pivoting direction has a length corresponding to about four to six times the length of the other longitudinal edge considered in the same direction, and that, during a cutting operation, a support of the cutting-edge part occurs via the leading longitudinal edge in the positive-fit receptacle.

According to a further preferred embodiment of the invention, it is provided that a leg, which is likewise formed integrally with the respective part, is further part of the tool body, which leg, together with the tool body itself and the leg-like stationary cutting part, delimits a substantially U-shaped cutting mouth with respect to a view in the direction of extension of a pivot axis, wherein, in a stop-limited basic position, the second cutting part lies substantially completely between the leg-forming partial sections of the tool body in a protected recessed position.

As a result of the enabled replaceability of the cutting-edge part, the cutting tool is advantageously further developed. Compared with the one-piece configurations of cutting-edge part and ratchet part known from the prior art, the proposed solution simplifies a desired replacement of the cutting part. Such a replacement may be necessary, for example, in the case of a cutting part having a blunt cutting edge or to adapt the cutting part to the material to be cut. For this purpose, a complete replacement including the ratchet part having the toothing for the ratchet drive is not required.

A cutting tool may thus be provided in which the cutting tip, relative to an otherwise linear course of the cutting edges, is formed to project in a pivoting direction of the second cutting part, the second cutting part essentially comprising a ratchet part and a cutting-edge part, wherein the cutting-edge part is replaceably received in the ratchet part.

The obtuse angle enclosed by the cutting edges of the second cutting part with respect to one another, in a view in which a geometric pivot axis of the second cutting part is represented as a point, may, according to a preferred embodiment, amount to more than 181°, for example more than about 185° up to about 240°, and is preferably about 205° to 215°.

The cutting tip, which is formed to project in the pivoting direction of the second cutting part, may advantageously comprise two tip cutting edges which, in the above-mentioned view, may enclose an acute angle with one another. In this respect, an angle of less than 89°, preferably less than about 85° and down to about 70°, may be obtained.

In a further possible embodiment, the tip cutting edges may enclose an obtuse angle of more than 90° with one another, for example an angle of about 95° or 100° or more, and further up to about 120°.

The tip cutting edges may, in the region of their transition into one another, extend in a substantially straight manner and form a point-shaped tip. In a further possible embodiment, however, the cutting tip may also be of rounded configuration. In that case, the tip cutting edges merge into one another while including a circular arc section.

These tip cutting edges laterally delimiting the cutting tip preferably extend, starting from the tip intersection point of the tip cutting edges, into a transition region to the respectively adjoining, otherwise substantially linearly extending cutting edges.

One or both of the tip cutting edges may each merge, via a cutting-edge rounding, into the adjoining linearly extending cutting edge. This rounded transition region may—preferably, and like the adjoining cutting edge or the tip cutting edge itself—be formed as a cutting edge, such that even in the region of this cutting-edge rounding a cutting effect can be achieved.

The amount of projection of the cutting tip, relative to an intersection point of the extended linearly extending cutting edges, may correspond to approximately 0.05 to 0.2 times the length of the linearly extending cutting edge leading toward the free end of the second cutting part. A corresponding amount of projection of the cutting tip may thus be, for example, more than 1 mm, preferably more than about 1.5 mm, up to about 5 mm or more, and in particular about 2 to 4 mm.

The cutting tool may be a pipe-cutting tool, the first cutting part being designed as a receiving part for a pipe to be cut. Such pipe-cutting tools are particularly used for cutting plastic pipes.

During a cutting operation, with pivoting of the second cutting part, according to a preferred embodiment, the cutting tip penetrates the outer surface of the pipe ahead of the linearly extending cutting edges and, during continuation of the cutting operation, likewise ahead of the regions of the linearly extending cutting edges that adjoin directly the tip cutting edges, and, where applicable, directly adjoin the intended cutting-edge roundings, penetrates the inner surface of the pipe. In this case, both upon an initial incision of the workpiece as the second cutting part immerses into the outer surface of the pipe and upon emergence of the second cutting part from the pipe interior toward the outside, a point-like loading of the pipe wall is effected by means of the cutting tip. Starting from this point-like penetration position of the cutting tip into the outer surface or into the inner surface of the pipe, a respective cutting path develops—with further pivoting displacement of the second cutting part-on both sides in opposite directions along the circumferential direction of the pipe.

As a result of the pivoting of the cutting tip along a circular line, during penetration into the outer surface and/or inner surface of the pipe, it preferably cuts at first substantially only with the one tip cutting edge that faces the circle center. In the course of further pivoting of the cutting tip, this tip cutting edge is preferably followed by the associated cutting-edge rounding and the adjoining section of the linearly extending cutting edge. At the same time, after the penetration of the tip cutting edge facing the circle center, during further pivoting, the tip cutting edge facing away from the circle center may penetrate the outer and/or inner surface in a cutting manner, followed by the adjoining cutting-edge rounding and the subsequent linearly extending cutting edge. Accordingly, when the cutting tip penetrates the respective surface of the workpiece, a cutting path results, starting from the cutting tip, on both sides in opposite directions along the circumferential direction.

In the case of a replaceable reception of the cutting-edge part in the ratchet part, a positive-fit receptacle for a portion of the cutting-edge part may be formed in the ratchet part. The positive-fit receptacle may, and preferably does, provide a support of the cutting-edge part, particularly during a pivoting displacement of the second cutting part in the cutting direction. The received portion of the cutting-edge part is preferably the end region of the cutting-edge part that faces away from the free end.

The cutting-edge part may, for example, be screwed to the ratchet part. In this respect, a plug-in or snap-in connection may alternatively be provided.

In a further embodiment, the positive-fit receptacle may be configured as an insertion pocket. In this case, a slot-shaped insertion opening oriented in the direction of extension of the cutting-edge part to be received may be formed. In particular, in the inserted form-locking position, the corresponding end of the cutting-edge part is preferably completely enclosed within the insertion pocket, except for the cutting-effective portion of the cutting-edge part that extends beyond the insertion opening.

The insertion pocket may be formed by a corresponding slot-shaped recess in the ratchet part. In an alternative embodiment, and further preferably, the insertion pocket may be formed by a depression in the ratchet part, which depression-preferably after insertion of the corresponding end section of the cutting-edge part—is coverable by a cover element.

The cover part may be fastened separately to the ratchet part. A preferred embodiment is one in which, when the cutting-edge part is held to the ratchet part via a screw connection, the screw is simultaneously used for securing the cover part in the covering position.

In its portion received in the positive-fit receptacle, the cutting-edge part may have an essentially rectangular base shape, as seen in a view in which the geometric pivot axis appears as a point. The positive-fit receptacle, such as the depression in the ratchet part, may be configured correspondingly rectangular in plan view, so that an essentially positive-fitting reception is achieved.

In this case, the positive-fit receptacle may have two opposite longitudinal edges, which may be of different lengths. Thus, one longitudinal edge-preferably the first longitudinal edge viewed in the cutting pivoting direction—may have a length corresponding to approximately four to eight times, and more particularly about six to seven times, the length of the second longitudinal edge.

The longitudinal edges of the positive-fit receptacle described above may be oriented in a secant-like manner with respect to an imaginary pivot circle about the circle center point, for example with respect to the pivot circle passing through the cutting tip. In this case, the two longitudinal edges may, and preferably do, extend at least substantially parallel to one another.

The ranges or multiple ranges of values specified above and below also include, with respect to the disclosure, all intermediate values, in particular in 1/10 increments of the respective dimension, possibly also dimensionless. For example, the range specification of 100 to 110° also includes the disclosure of 100.1 to 110°, 100 to 109.9°, 100.1 to 109.9°, etc.; the disclosure of 2 to 4 mm also includes 2.1 to 4 mm, 2 to 3.9 mm, 2.1 to 3.9 mm, etc.; the disclosure of “four- to eightfold” also includes 4.1- to 8-fold, 4- to 7.9-fold, 4.1- to 7.9-fold, etc. This disclosure may serve, on the one hand, for delimiting a specified range limit from below and/or above, alternatively or additionally also for disclosing one or more singular values from a given range.

### BRIEF DESCRIPTION OF THE DRAWINGS

The invention will be explained in greater detail below with reference to exemplary embodiments. In the drawings:

FIG. 1 shows the cutting tool in a side view, relating to a first embodiment;

FIG. 2 shows the front view of the cutting tool according to arrow II in FIG. 1;

FIG. 3 shows the cutting tool of the first embodiment schematically, illustrating its use;

FIG. 4 shows the cutting tool according to FIG. 1 in a partially sectional side view, illustrating a pivoted-out basic position of a second cutting part, with a workpiece received in a cutting mouth;

FIG. 5 shows an intermediate position during a pivoting displacement of the second cutting part in the cutting direction;

FIG. 6 shows an enlarged view of detail VI in FIG. 5;

FIG. 7 shows a subsequent view to FIG. 5 in a further pivoting position of the second cutting part;

FIG. 8 shows an enlarged view of detail VIII in FIG. 7;

FIG. 9 shows a subsequent view to FIG. 7 in a further pivoting position of the second cutting part;

FIG. 10 shows a subsequent view to FIG. 9 in a further pivoting position of the second cutting part;

FIG. 11 shows an enlarged view of detail XI in FIG. 10;

FIG. 12 shows a subsequent view to FIG. 10, illustrating the final cutting position;

FIG. 13 shows a cutting-edge part of the second cutting part in a separate illustration;

FIG. 13a shows a view according to FIG. 13 relating to an alternative embodiment;

FIG. 14 shows the cutting-edge part and a ratchet part in a perspective exploded view;

FIG. 15 shows the section in the plane XV of FIG. 14, with the cutting-edge part received in a positive-fit receptacle of the ratchet part;

FIG. 16 shows a sectional view according to FIG. 15, but with the cutting-edge part removed;

FIG. 17 shows the view of the second cutting part composed of the cutting-edge part and the ratchet part, according to arrow XVII in FIG. 14;

FIG. 18 shows the section along line XVIII-XVIII in FIG. 17;

FIG. 19 shows a sectional view according to FIG. 18, but with the cutting-edge part removed;

FIG. 20 shows, in a perspective exploded view, the second cutting part of a cutting tool in a second embodiment.

### DESCRIPTION OF THE EMBODIMENTS

Shown and described is a hand-actuated cutting tool 1 having a first, stationary handle part 2 and a second, pivotally movable handle part 3, as well as a first, stationary cutting part 4 and a second cutting part 5, which is pivotally movable relative to the cutting part 4.

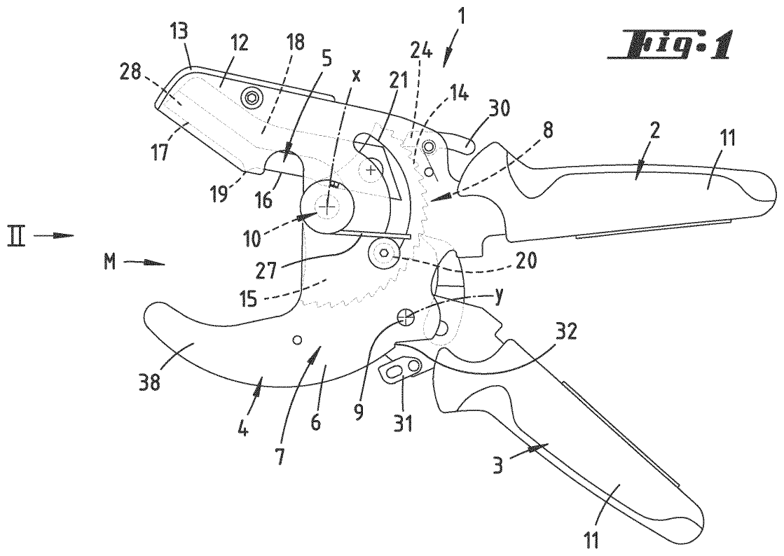

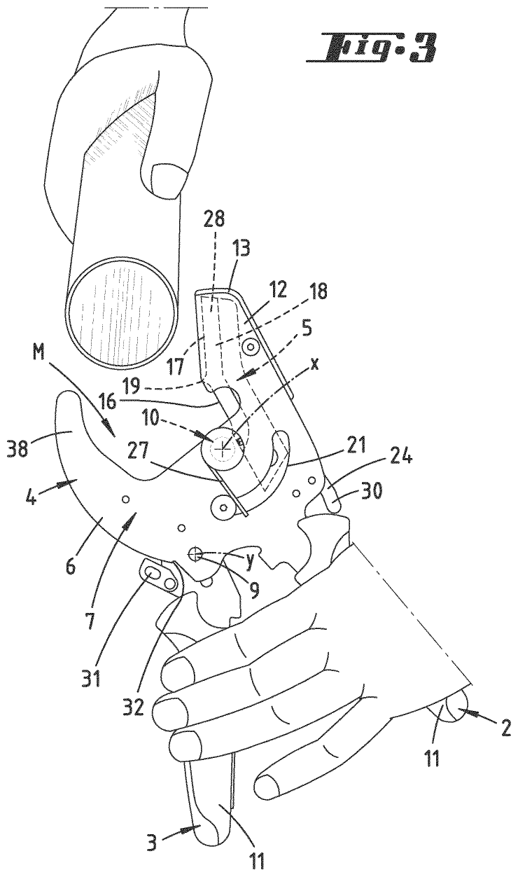

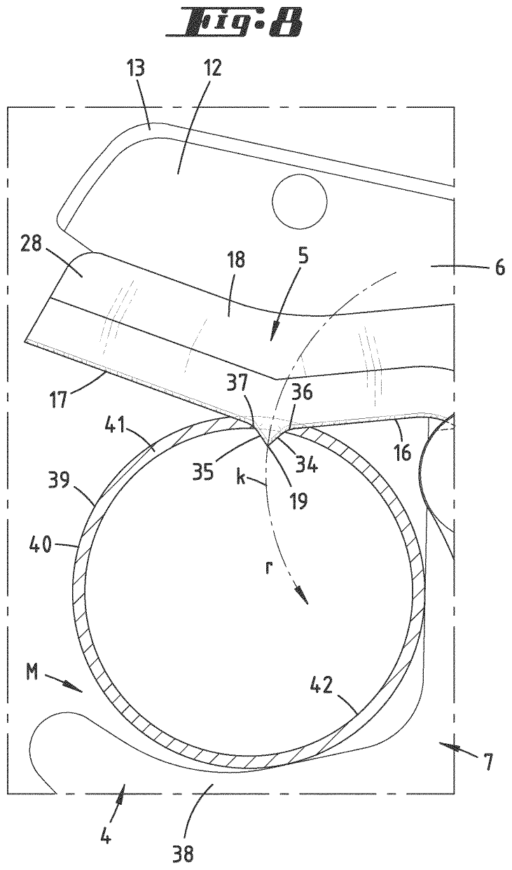

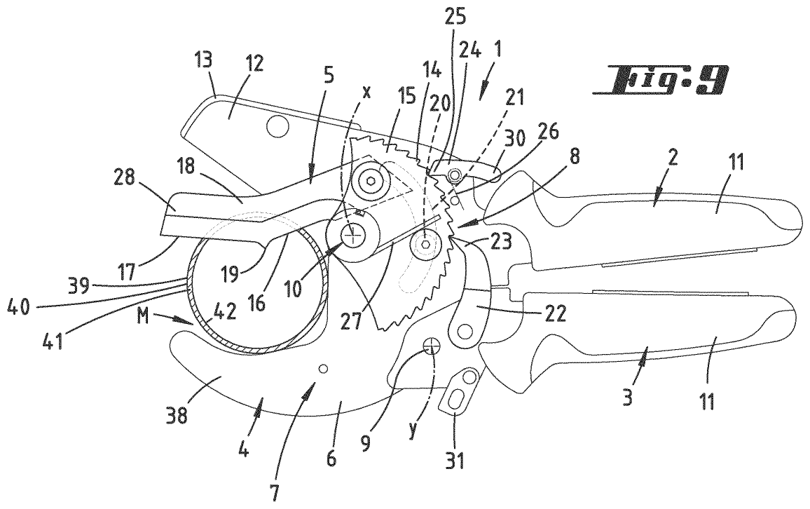

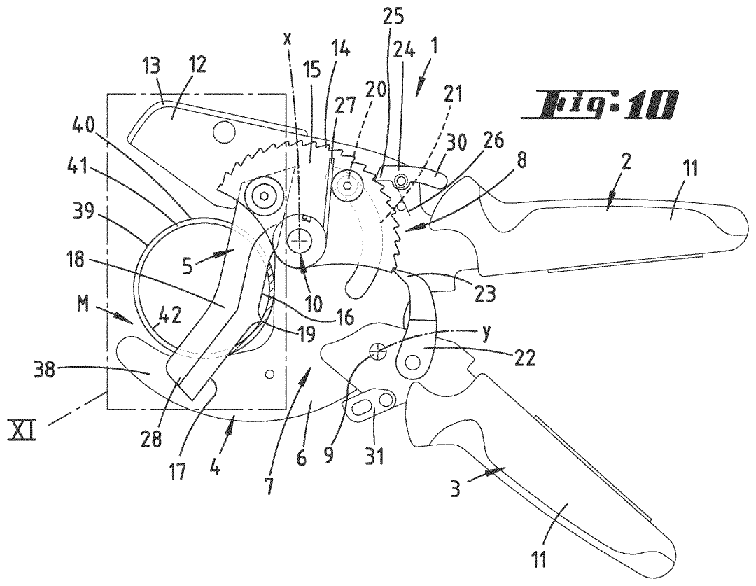

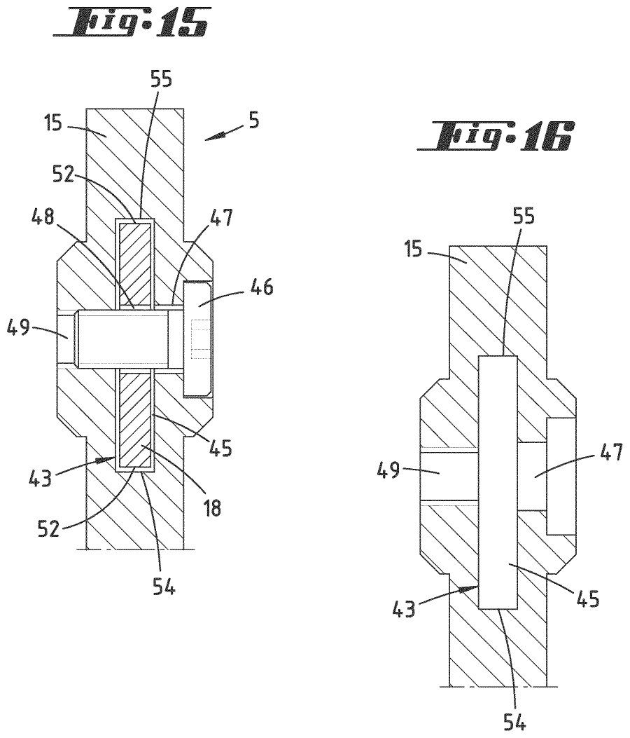

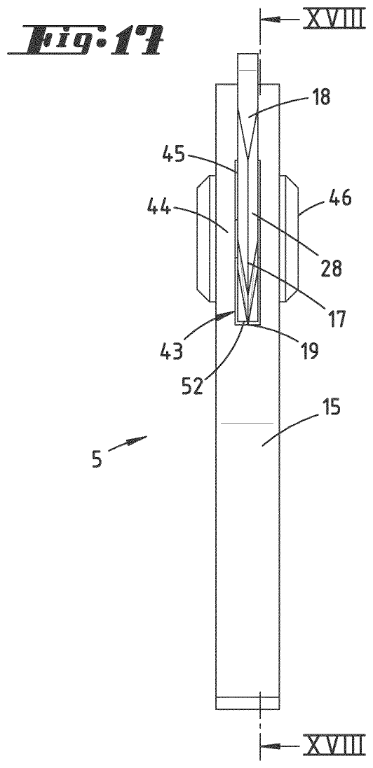

FIGS. 1 to 19 show a first embodiment of the cutting tool 1 in the form of a pipe-cutting tool. FIG. 20 shows a second embodiment with respect to the configuration of the second cutting part 5.

Starting from a preferably plate-like tool body 7, the first, stationary handle part 2 preferably extends integrally and, further preferably, materially unitary. Essentially opposite thereto, the first stationary cutting part 4 also preferably extends as a single piece and, further preferably, materially unitary, in the form of a freely projecting arm.

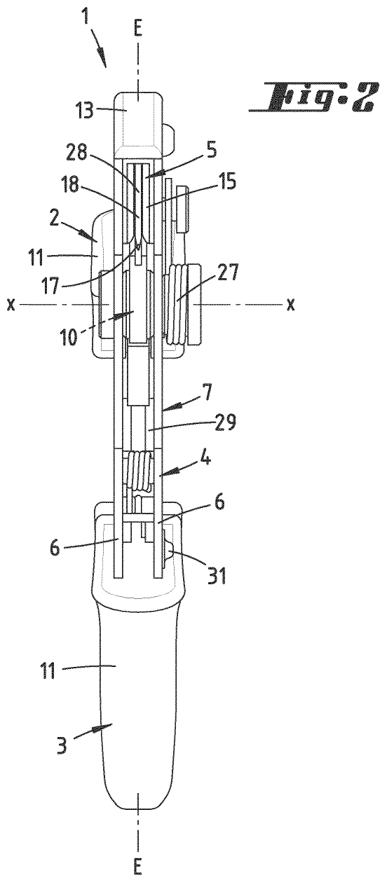

As can be seen particularly from FIG. 2, two spaced-apart, preferably plate-shaped parts 6, in particular stamped parts, more particularly stamped steel sheet parts, form the tool body 7. These two parts 6 forming the tool body 7 may be substantially identical in shape and extend spaced apart from each other in the direction of a geometric pivot axis x described below.

Between the parts 6 of the tool body 7, there are arranged essentially the second cutting part 5, which is movable about the pivot axis x, and preferably a ratchet drive 8. Furthermore, an end portion of the second, pivotally movable handle part 3 preferably extends into the intermediate space between the parts 6 of the tool body 7. This handle part 3 is preferably mounted on the tool body 7 by means of a pivot pin 9. A corresponding geometric pivot axis y extends preferably parallel in space to the geometric pivot axis x in the joint 10 of the second cutting part 5.

The handle parts 2, 3 may, as shown, each be provided with a handle sleeve 11.

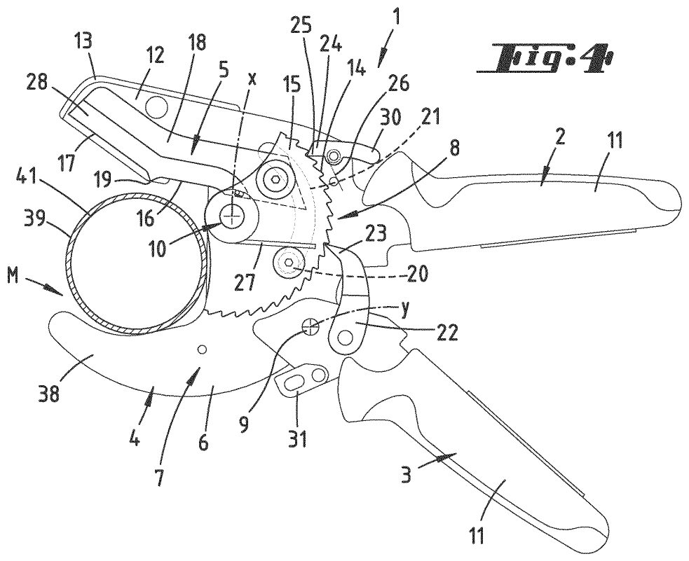

In FIGS. 4 to 12, only for the sake of clarifying the mechanism and the structure and mode of operation, the front part 6 (in viewing direction) is not shown.

Further, part of the rigid tool body 7 is a leg 12, likewise preferably formed integrally and, further preferably, materially unitary with the respective part 6. Together with the tool body 7 itself and the arm-like stationary cutting part 4, this leg 12 delimits a U-shaped cutting mouth M when viewed in the direction of extension of the pivot axis x. The two parts 6 forming the leg 12 may, as shown, be covered by a cap 13 made, for example, of a plastic material.

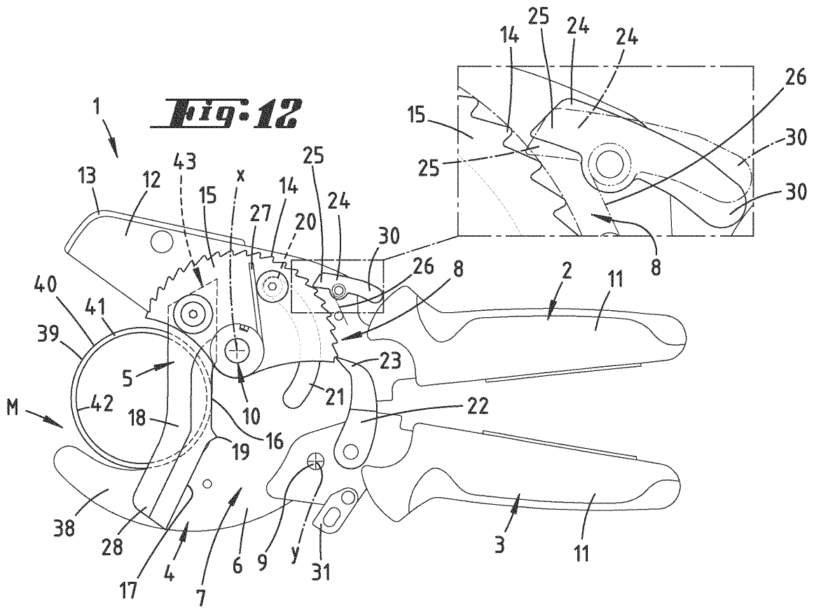

The second, pivotably movable cutting part 5 may, as also shown, essentially be composed of a ratchet part 15 which, on its outer side along a peripheral edge viewed in the circumferential direction, has a toothing 14, and of a cutting-edge part 18 having straight-line cutting edges 16, 17. The cutting edges 16 and 17, which are arranged essentially one behind the other in the longitudinal extent L of the cutting-edge part 18, enclose with one another an obtuse angle α of about 190° to 210° and converge in a cutting tip 19 pointing in the pivoting direction r (compare FIG. 13).

This results in a movement of the second cutting part 5 in a cutting plane E formed between the parts 6 (compare FIG. 2).

The pivotability of the second cutting part 5 may be limited by a stop, in particular in the basic position of the second cutting part 5 shown, for example, in FIGS. 1 to 4, due to interaction of a guide pin 20 with a guide groove 21 provided in the parts 6 of the tool body 7 and extending coaxially to the pivot axis x. In this stop-limited basic position, the second cutting part 5, in particular the cutting edges 16 and 17 of the cutting-edge part 18, may preferably lie essentially completely between the sections of the parts 6 forming the leg 12, in a protected hidden position.

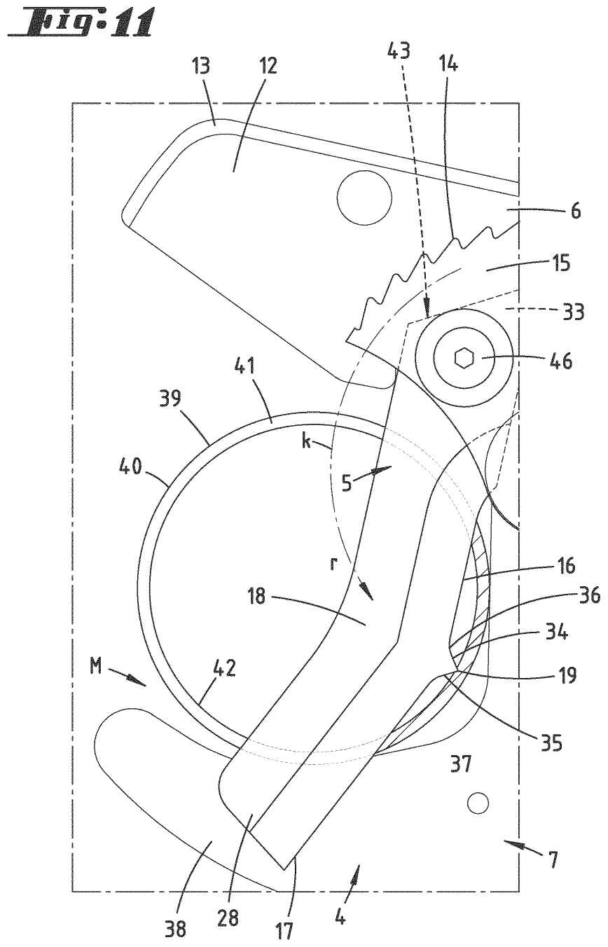

In the course of a pivoting displacement of the second cutting part 5 starting from the basic position in a pivoting direction r, the guide pin 20 travels along the guide groove 21. Even in a pivot end position, as shown for example in FIG. 12, a stop limitation can be provided by the guide pin 20 bearing against the respective end of the guide groove 21.

The pivoting displacement of the second cutting part 5 in the pivoting direction r takes place in the exemplary embodiment, and preferably, by use of the ratchet drive 8. For this purpose, the handle part 3 may be provided with a feed lever 22 pivotally mounted thereon. This feed lever 22 engages, with a free end feed pawl 23, in the toothing 14 of the ratchet part 15. A pivoting displacement of the second handle part 3 towards the handle part 2 fixed relative thereto leads, via the engagement of the feed pawl 23 in the toothing 14, to a partial pivoting displacement of the second cutting part 5. A locking lever 24, which is furthermore pivotally mounted on the tool body 7, in particular between the parts 6, prevents, by means of a locking pawl 25 likewise engaging in the toothing 14, a return displacement of the pivotable cutting part 5 counter to the pivoting direction r, so that, even when the movable handle part 3 is pivoted back into a position spaced from the stationary handle part 2, the second cutting part 5 remains in the previously reached pivoted position.

Both the feed lever 22 and the locking lever 24 are, in the usual manner, biased into their engagement position with the toothing 14 by springs, in particular leg springs, such as the leg spring 26 of the locking lever 24. The respective spring acts with one leg on the associated lever, while the other leg of the spring preferably bears against the rigid tool body 7.

The feed displacement of the second cutting part 5 in the pivoting direction r takes place against the force of a return spring 27 acting on the second cutting part 5. Thus, as also shown, a leg spring may be provided in this context, which bears with one leg against the rigid tool body 7 and acts with the other leg, counter to the pivoting direction r, on the guide pin 20.

In the course of the advance displacement of the second cutting part 5 in the pivoting direction r, the cutting-edge part 18 passes, at least with a portion and more particularly with a free end 28 of the cutting-edge part 18, through an entry slot 29 which is formed between the legs of the tool body 7 forming the first, stationary cutting part 4. This entry slot 29 may, as is also preferred, be provided by the overall spaced-apart arrangement of the parts 6 (compare FIG. 2).

Further preferably, during the advance displacement and entry or passage through the entry slot 29, the movable cutting part 5, including the free end 28 of the cutting-edge part 18, does not project outward beyond the outer edge contour of the stationary cutting part 4 as viewed in the direction of the pivot axis x. Rather, in the entry slot 29, the free end 28 is covered on both sides by the leg sections of the parts 6 forming the stationary cutting part 4.

The locking lever 24 may have, on the side facing away from the locking pawl 25, a handle 30 accessible from the outside, by means of which the locking lever 24 can be pivoted such that its locking pawl 25 disengages from the toothing 14 (see enlarged detail in FIG. 12). The second cutting part 5 can thereafter, by action of the return spring 27, pivot back from the advanced position, with the feed pawl 23 overrunning in a ratcheting manner, into the basic position as shown, for example, in FIG. 1.

Moreover, the pivotably movable handle part 3 may be provided with a latching lever 31 which, in a latching position, can cooperate in a locking manner with a locking edge 32 of the tool body 7.

The cutting-edge part 18 is shown in a separate illustration in FIG. 13. As can be seen, the linearly extending cutting edge 17 extends from the cutting tip 19 to the free end 28, whereas the likewise linearly extending cutting edge 16 extends from the cutting tip 19 only over a partial section of the cutting-edge part 18 and, at the end of the cutting-edge part 18, leaves a cutting-edge-free region 33.

The cutting tip 19 is formed so as to project, relative to the otherwise linear course of the cutting edges 16 and 17, in the pivoting direction r (see also the enlarged detail in FIG. 13). In this context, a projection amount a of the cutting tip 19 relative to an intersection point S of the extended, linearly extending cutting edges 16 and 17 can correspond to approximately 0.05 to 0.1 times, and for example approximately 0.07 times, the length b of the cutting edge 17 extending linearly toward the free end 28 of the cutting-edge part 18.

The cutting tip 19 merges on both sides, toward the respective cutting edge 16 or 17, into tip cutting edges 34 and 35. As shown, these can extend essentially in a straight line and, in a view in which the pivot axis x of the second cutting part 5 is represented as a point, can enclose an acute angle β of about 75 to 89°, and further about 80 to 85° (see enlarged detail in FIG. 13).

According to a further possible embodiment, the tip cutting edges 34 and 35 may also enclose an obtuse angle β of more than 90°, for example about 95 or 100°, or more, and further up to about 120°.

As can further be seen from the illustration in FIG. 13a, the cutting tip 19 formed in the transition of the cutting edges 34 and 35 may also be of rounded configuration, for example having a radius R3 which may correspond to approximately 0.1 to 1 times, and for example approximately 0.4 to 0.6 times, the projection amount a.

According to the illustrated embodiments, both tip cutting edges 34 and 35 may merge, via a cutting-edge rounding 36, 37 with a radius R1 or R2 which corresponds to approximately 1.2 to 2 times, and further approximately 1.5 times, the projection amount a, into the associated cutting edge 16 or 17.

The first stationary cutting part 4 serves essentially as a receiving part 38 for supporting a material to be cut, for example a pipe 39 to be cut.

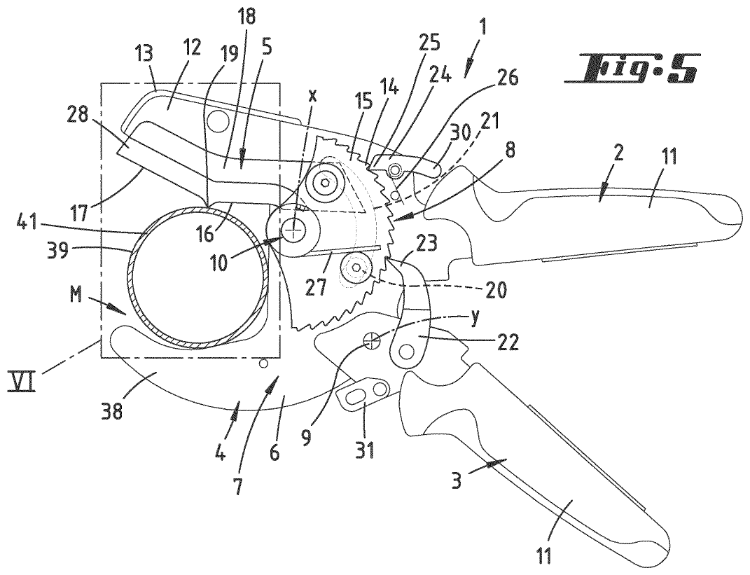

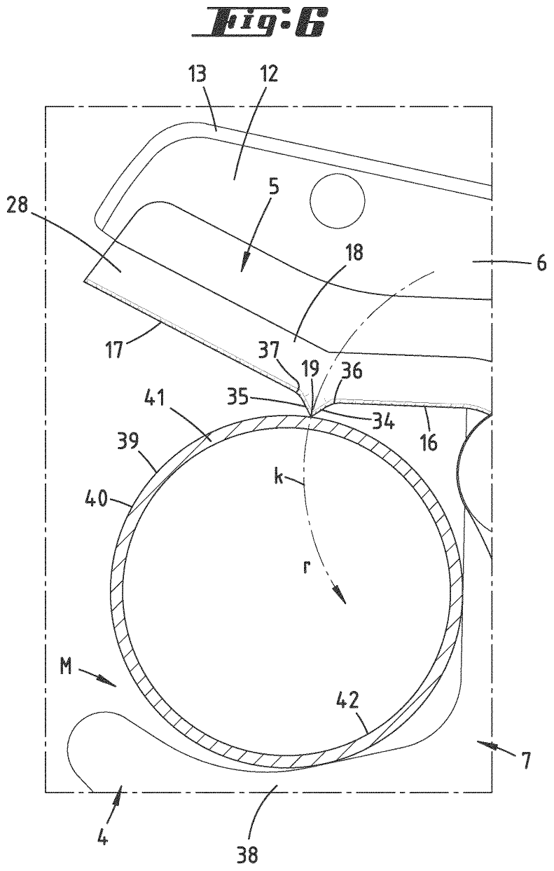

During the cutting operation, in which the second cutting part 5 with its cutting-edge part 18 is displaced in the pivoting direction r, the projecting cutting tip 19 first, ahead of the linearly extending cutting edges 16 and 17, engages the outer surface 40 of the pipe 39 (see FIGS. 5 and 6). This results in an approximately point-like force application via the cutting tip 19, as a result of which initial penetration of the cutting tip 19 into the pipe wall 41 and subsequent penetration of the cutting tip 19 together with the adjoining cutting portions through the pipe wall 41 is facilitated.

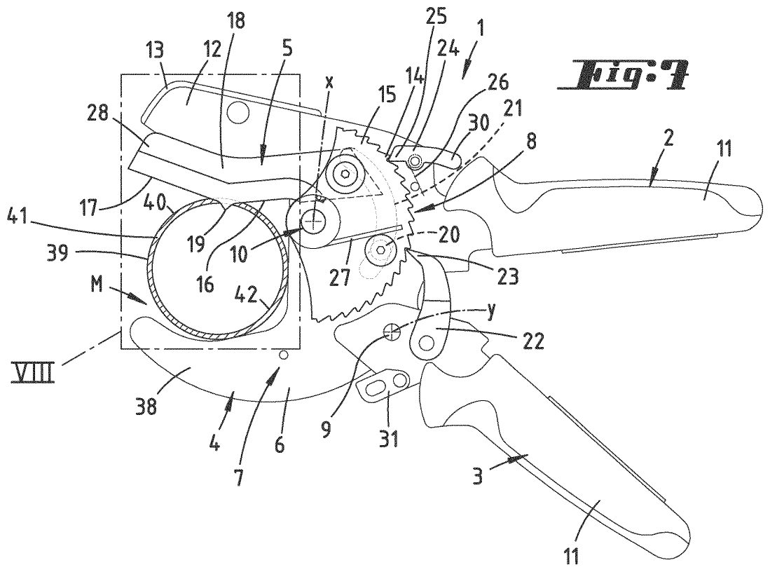

As the cutting tip 19 pivots along a circular line k, during penetration into the outer surface 40 and/or through the pipe wall 41, primarily the tip cutting edge 34 facing the circle center KM first cuts into the pipe 39, followed by the opposite tip cutting edge 35, both cutting-edge roundings 36 and 37, and the linearly extending cutting edges 16 and 17 (see also FIGS. 7 to 9). Upon initial penetration of the pipe wall 41, a cutting path is produced starting from the cutting tip 19 on both sides in the circumferential direction.

As the cutting operation continues, the cutting tip 19 again, ahead of the areas of the cutting edges 16 and 17 immediately adjoining the tip cutting edges 34 and 35, penetrates the inner surface 42 of the pipe 39. Here too, during penetration of the pipe wall 41 from inside to outside, a cutting path is produced starting from the cutting tip 19 on both sides in the circumferential direction, meeting the cutting path otherwise produced by the linear cutting edges 16 and 17 (see FIGS. 10 to 12).

The cutting-edge part 18 may be replaceably received in the ratchet part 15. For this purpose, a positive-fit connection between the cutting-edge-free portion 33 of the cutting-edge part 18 and a positive-fit receptacle 43 of the ratchet part 15 is preferably provided.

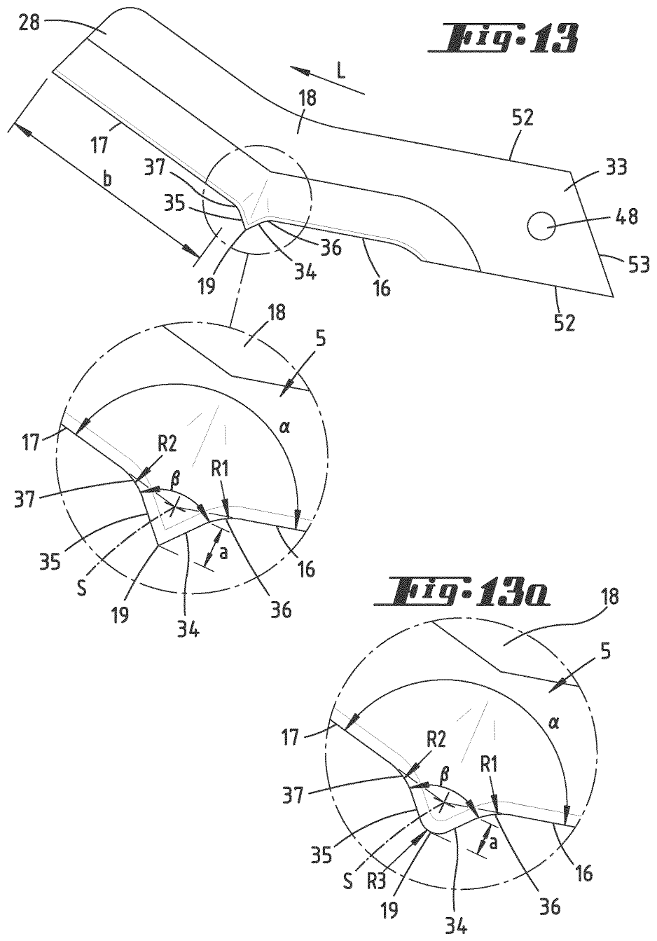

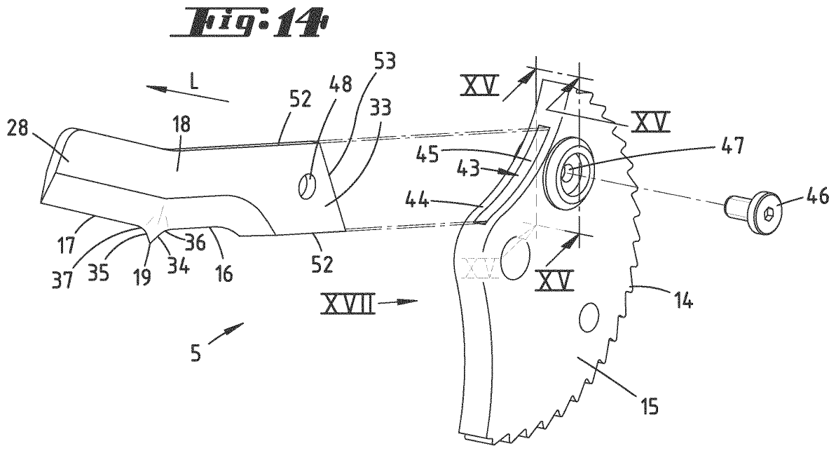

According to the illustrations in FIGS. 14 to 19, in the first embodiment shown there, the positive-fit receptacle 43 may be formed by a slot-shaped receiving pocket 45 which opens into an edge surface 44 of the ratchet part 15 facing away from the toothing 14. Through the slot opening, the cutting-edge part 18 with its portion 33 can be inserted into the receiving pocket 45. The insertion position can be secured by a screw 46, which passes through an opening 47 in the ratchet part 15 and, after passing through a correspondingly positioned bore 48 in the portion 33 of the cutting-edge part 18, engages at the end of its shaft into a threaded bore 49 formed in the cheek of the cutting-edge part 18 (compare in particular FIG. 15).

In this first embodiment, the portion 33 of the cutting-edge part 18 received in the receiving pocket 45 is completely surrounded-except for the exit opening of the receiving pocket 45—directly by the material of the ratchet part 15.

According to the illustration in FIG. 20, in a second embodiment, the receiving pocket 45 may also be formed as a recess 50 in the surface of the ratchet part 15, which recess 50, in particular in the holding position of the cutting-edge part 18, is covered by a preferably shape-matched cover part 51.

The portion 33 of the cutting-edge part 18 to be received in the receiving pocket 45 may have an essentially rectangular outline with two opposite longitudinal edges 52 that preferably extend substantially parallel to one another, and with a narrow edge 53 extending at an acute angle of about 45 to 60° to one of the longitudinal edges 52.

The positive-fit receptacle 43 or the receiving pocket 45 has a contour adapted to the portion 33, with two opposite longitudinal edges 54 and 55 extending substantially parallel to one another, and with a transverse edge 56 aligned in correspondence with the course of the narrow edge 53 of the portion 33.

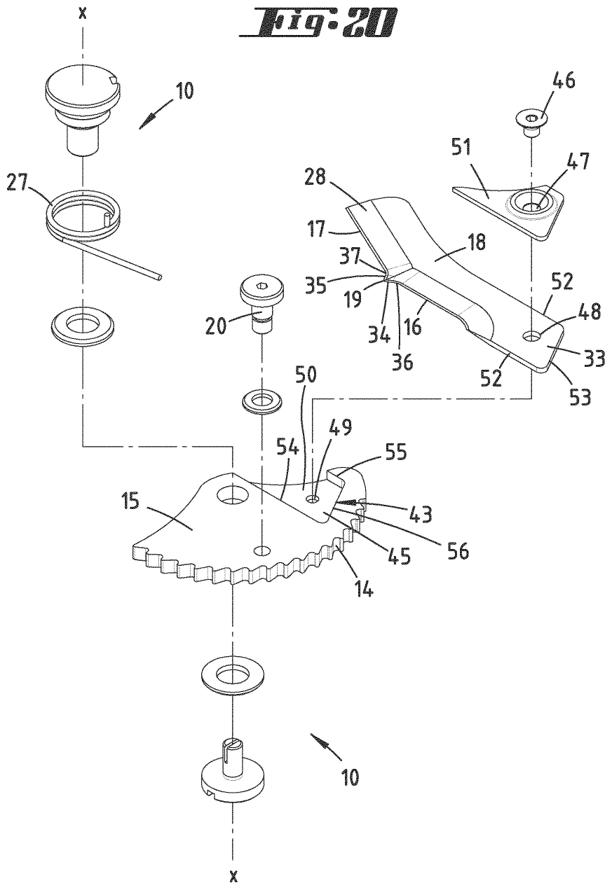

The longitudinal edges 54 and 55 are formed to be of different lengths, wherein the longitudinal edge 54 leading in the pivoting direction r may have a length c corresponding to approximately four to six times, and further approximately five times, the length d of the other longitudinal edge 55 considered in the same direction (compare, for example, FIG. 19).

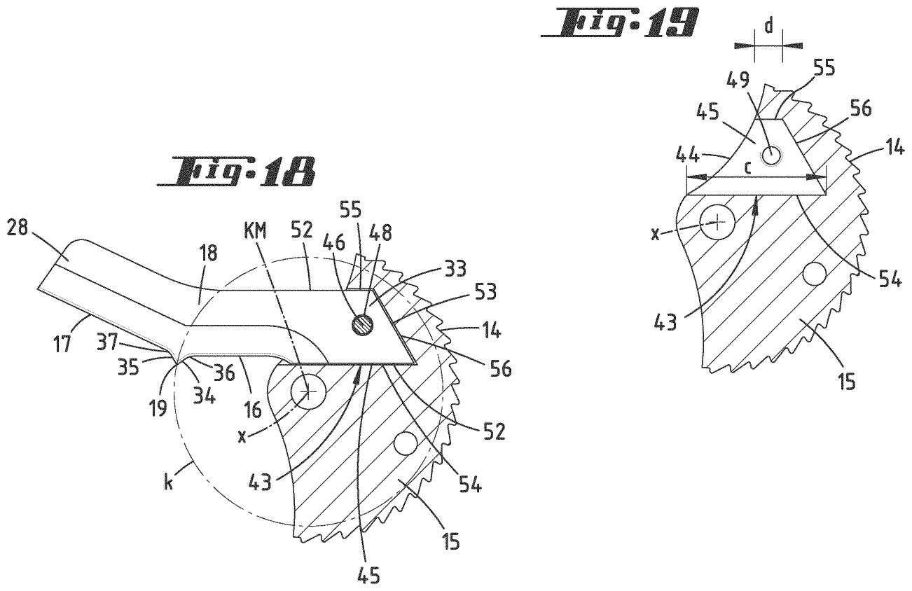

With respect to an imaginary pivot circle, for example defined by the circular line k, the above-mentioned longitudinal edges 54 and 55 extend, optionally in their notional extension, in a secant-like manner (see FIG. 18).

In the course of a cutting operation, in particular a support of the cutting-edge part 18 via the leading longitudinal edge 52, and more particularly via the end section of the longitudinal edge 52 facing the narrow edge 53, at the associated longitudinal edge 54 in the positive-fit receptacle 43, may be provided. Alternatively or additionally, in the course of the cutting operation, a corresponding support of the narrow edge 53 at the associated transverse edge 56 of the positive-fit receptacle 43 may also be provided.

The foregoing explanations serve to elucidate the inventions covered by the application as a whole, which further develop the prior art independently in each case by at least the following combinations of features, wherein two, several or all of these combinations of features may also be combined with one another, namely:

A cutting tool, characterized in that the cutting tip 19 is formed so as to project, relative to an otherwise linear course of the cutting edges 16, 17, in a pivoting direction r of the second cutting part 5.

A cutting tool, characterized in that the cutting tip 19 has two tip cutting edges 34, 35 which enclose an acute angle β with one another.

A cutting tool, characterized in that the tip cutting edges 34, 35 enclose an obtuse angle β with one another.

A cutting tool, characterized in that one or both of the tip cutting edges 34, 35 merge, via a cutting-edge rounding 36, 37, into the linearly extending cutting edges 16, 17.

A cutting tool, characterized in that the projection amount a of the cutting tip 19, relative to an intersection point S of the extended linearly extending cutting edges 16, 17, corresponds to 0.05 to 0.2 times the length b of the cutting edge 17 extending linearly toward a free end 28 of the second cutting part 5 remote from the joint 10.

A cutting tool, characterized in that the cutting tool 1 is a pipe-cutting tool and that the first cutting part 4 is configured as a receiving part 38 for a pipe 39 to be cut.

A cutting tool, characterized in that, during a cutting operation involving pivoting of the second cutting part 5, the cutting tip 19 first, ahead of the linearly extending cutting edges 16, 17, penetrates the outer surface 40 of the pipe 39, and during continuation of the cutting operation, ahead of the areas of the linearly extending cutting edges 16, 17 immediately adjoining the tip cutting edges 34, 35, penetrates the inner surface 42 of the pipe 39.

A cutting tool, characterized in that the cutting tip 19, as a result of pivoting along a circular line k, during penetration into the outer surface 40 and/or inner surface 42 of the pipe 39, initially cuts essentially only with the tip cutting edge 34 facing the circle center KM into the pipe 39.

A cutting tool 1 with two cutting parts 4, 5, the cutting parts 4, 5 being connected to one another in a joint 10 for pivoting movement relative to one another along a cutting plane E, wherein furthermore a first cutting part 4 is considered stationary and a second cutting part 5 is considered movable, which cutting parts 4, 5 in an open state define a cutting mouth M, and wherein furthermore the second cutting part 5 is drivable via a ratchet drive 8 and consists of a ratchet part 15 provided with a toothing 14 and a cutting-edge part 18, or a cutting tool 1 according to one of claims 1 to 8, characterized in that the cutting-edge part 18 is replaceably received in the ratchet part 15.

A cutting tool, characterized in that a positive-fit receptacle 43 for a portion 33 of the cutting-edge part 18 is formed in the ratchet part 15.

A cutting tool, characterized in that the cutting-edge part 18 is screw-connected to the ratchet part 15.

A cutting tool, characterized in that the positive-fit receptacle 43 is configured as a receiving pocket 45.

A cutting tool, characterized in that the receiving pocket 45 is formed by a recess 50 in the ratchet part 15, which recess 50 can be covered by a cover part 51.

A cutting tool, characterized in that the cutting-edge part 18, in its portion 33 received in the positive-fit receptacle 43, has an essentially rectangular outline.

A cutting tool, characterized in that the positive-fit receptacle 43 has two opposite longitudinal edges 54, 55 of different lengths.

A cutting tool, characterized in that the longitudinal edges 54, 55 extend, with respect to an imaginary pivot circle, in a secant-like manner.

All disclosed features are essential to the invention (individually as well as in combination with one another). The disclosure content of the associated/appended priority documents (copy of the prior application) is hereby incorporated in its entirety into the disclosure of the present application, also for the purpose of incorporating features of those documents into the claims of the present application. The dependent claims characterize, even without the features of a referenced claim, independent inventive further developments of the prior art with their features, in particular for the purpose of filing divisional applications based on these claims. The invention as specified in each claim may additionally have one or more of the features indicated in the foregoing description, in particular those provided with reference numerals and/or listed in the reference numeral list. The invention also relates to embodiments in which individual features mentioned in the foregoing description are not implemented, particularly insofar as they are evidently dispensable for the respective intended use or can be replaced by other technically equivalent means.

List of reference signs

| | |
|---|---|
| 1 | cutting tool |
| 2 | first handle part |
| 3 | second handle part |
| 4 | first cutting part |
| 5 | second cutting part |
| 6 | parts |
| 7 | tool body |
| 8 | ratchet drive |
| 9 | pivot pin |
| 10 | joint |
| 11 | handle sleeve |
| 12 | leg |
| 13 | cap |
| 14 | toothing |
| 15 | ratchet part |
| 16 | cutting edge |
| 17 | cutting edge |
| 18 | cutting-edge part |
| 19 | cutting tip |
| 20 | guide pin |
| 21 | guide groove |
| 22 | feed lever |
| 23 | feed pawl |
| 24 | locking lever |
| 25 | locking pawl |
| 26 | leg spring |
| 27 | return spring |
| 28 | free end |
| 29 | entry slot |
| 30 | handle |
| 31 | latching lever |
| 32 | locking edge |
| 33 | portion |
| 34 | tip cutting edge |
| 35 | tip cutting edge |
| 36 | cutting-edge rounding |
| 37 | cutting-edge rounding |
| 38 | receiving part |
| 39 | pipe |
| 40 | outer surface |
| 41 | pipe wall |
| 42 | inner surface |
| 43 | positive-fit receptacle |
| 44 | edge surface |
| 45 | receiving pocket |
| 46 | screw |
| 47 | opening |
| 48 | bore |
| 49 | threaded bore |
| 50 | recess |
| 51 | cover part |
| 52 | longitudinal edge |
| 53 | narrow edge |
| 54 | longitudinal edge |
| 55 | longitudinal edge |
| 56 | transverse edge |
| a | projection amount |
| b | length |
| c | length |
| d | length |
| k | circular line |
| r | pivoting direction |
| x | pivot axis |
| y | pivot axis |
| E | cutting plane |
| KM | circle center |
| L | longitudinal extent |
| M | cutting mouth |
| R1 | radius |
| R2 | radius |
| R3 | radius |
| S | intersection point |
| α | angle |
| β | angle |

1. A cutting tool (1) having two cutting parts (4, 5) comprising a first cutting part (4) and a second cutting part (5), the two cutting parts (4, 5) being connected to one another by in a joint (10) for pivoting movement relative to one another along a cutting plane (E), wherein the first cutting part (4) is considered stationary and the second cutting part (5) is considered movable, which cutting parts (4, 5) define a cutting mouth (M) in an open state, wherein, starting from a tool body (7), a first, stationary handle part (2) extends and, substantially opposite thereto, the first stationary cutting part (4) extends, in the manner of a freely projecting leg, wherein the tool body (7) is formed by two parts (6) arranged at a distance from one another, wherein the second cutting part (5) is pivotable and has two cutting edges (16, 17) enclosing an obtuse angle (β) with one another and converging in a cutting tip (19), a leg (12), which is formed integrally with a respective one of the parts (6) of the tool body (7), and which, together with the tool body (7) itself and the stationary cutting part (4), delimits a substantially U-shaped cutting mouth (M) with respect to a view in the direction of extension of a pivot axis (x), wherein the cutting tip (19), relative to an otherwise linear course of the cutting edges (16, 17), is formed so as to project in a pivoting direction (r) of the second cutting part (5) by a projection amount (a), and wherein, in a stop-limited basic position, the second cutting part (5) lies substantially completely between the leg-forming partial sections of the tool body (7) in a protected, recessed position.

2. The cutting tool according to claim 1, wherein the cutting tip (19) has two tip cutting edges (34, 35) which enclose an acute angle (B) with one another.

3. The cutting tool according to claim 1, wherein the cutting tip (19) has two the tip cutting edges (34, 35) that enclose an obtuse angle (B) with one another.

4. The cutting tool according to claim 2, wherein one or both of the tip cutting edges (34, 35) merge, via a cutting-edge rounding (36, 37), into the linearly extending cutting edges (16, 17).

5. The cutting tool according to claim 1, wherein a projection amount (a) of the cutting tip (19), relative to an intersection point(S) of the extended linearly extending cutting edges (16, 17), corresponds to 0.05 to 0.2 times a length (b) of the cutting edge (17) extending linearly toward a free end (28) of the second cutting part (5) remote from the joint (10).

6. The cutting tool according to claim 1, wherein the cutting tool (1) is a pipe-cutting tool and wherein the first cutting part (4) is configured as a receiving part (38) for a pipe (39) to be cut.

7. The cutting tool according to claim 2, wherein the cutting tool (1) is a pipe-cutting tool, and wherein, during a cutting operation involving pivoting of the second cutting part (5), the cutting tip (19) first, ahead of the linearly extending cutting edges (16, 17), penetrates an outer surface (40) of the pipe (39) and, during continuation of the cutting operation, ahead of areas of the linearly extending cutting edges (16, 17) immediately adjoining the tip cutting edges (34, 35), penetrates an inner surface (42) of the pipe (39).

8. The cutting tool according to claim 7, wherein, as a result of pivoting along a circular line (k), the cutting tip (19), during penetration into the outer surface (40) and/or inner surface (42) of the pipe (39), initially cuts substantially only with the tip cutting edge (34) facing the circle center (KM) into the pipe (39).

9. The cutting tool according to claim 1, wherein the second cutting part (5) is drivable via a ratchet drive (8) and consists of a ratchet part (15) provided with a toothing (14) and a cutting-edge part (18), the cutting-edge part (18) being replaceably received in the ratchet part (15), wherein a positive-fit receptacle (43) for a portion (33) of the cutting-edge part (18) is formed in the ratchet part (15).

10-16. (canceled)

17. The cutting tool according to claim 9, wherein longitudinal edges (54, 55) of the positive-fit receptacle (43) are of different lengths, wherein a longitudinal edge (54) leading in a pivoting direction r has a length c corresponding to about four to six times a length d of the other longitudinal edge (55) considered in the same direction, and wherein, during a cutting operation, a support of the cutting-edge part (18) takes place via the leading longitudinal edge (54) in the positive-fit receptacle (43).

18. The cutting tool according to claim 9, wherein the cutting-edge part (18) is screw-connected to the ratchet part (15).

19. The cutting tool according to claim 9, wherein the cutting-edge part (18), in a portion (33) received in the positive-fit receptacle (43), has a substantially rectangular outline.

20. The cutting tool according to claim 9, wherein the longitudinal edges (54, 55) extend secant-like with respect to an imaginary pivot circle.

21. The cutting tool according to claim 9, wherein a positive-fit receptacle (43) for a portion (33) of the cutting-edge part (18) is formed in the ratchet part (15).

22. The cutting tool according to claim 21, wherein the positive-fit receptacle (43) is configured as a receiving pocket (45), wherein the portion of the cutting-edge part (18) received in the receiving pocket (45) is completely enclosed directly by material of the ratchet part (15), or wherein the receiving pocket (45) is formed by a recess (50) in the ratchet part (15), and further comprising a cover part (51) that is configured to cover the recess (50).
